(19) United States
(12) Patent Application Publication
(10) Pub. No.: US 2013/0230196 A1
(43) Pub. Date: Sep. 5, 2013

(54) OSCILLATORY WAVE MOTOR AND SOUND GENERATION DEVICE USING OSCILLATORY WAVE MOTOR AS DRIVE SOURCE

(71) Applicants: Hirokazu Negishi, Kanagawa (JP); Ikuo Oohira, Kanagawa (JP); Juro Ohga, Kanagawa (JP); Takaaki Ishii, Yamanashi (JP)

(72) Inventors: Hirokazu Negishi, Kanagawa (JP); Ikuo Oohira, Kanagawa (JP); Juro Ohga, Kanagawa (JP); Takaaki Ishii, Yamanashi (JP)

(73) Assignee: NIKKO COMPANY, Hakusan-shi, Ishikawa (JP)

(21) Appl. No.: 13/884,522

(22) PCT Filed: Nov. 8, 2011
(86) PCT No.: PCT/JP2011/075728

§ 371 Date: May 9, 2013

(30) Foreign Application Priority Data
Nov. 10, 2010 (JP) 2010-251434

(51) Int. Cl. H02N 2/00; H02N 2/12

(52) U.S. Cl. CPC H02N 2/0065; H02N 2/12
USPC 381/162; 310/323.03

(57) ABSTRACT

The present invention addresses the problem of increasing the lifetimes of an oscillatory wave motor and a sound generation device using the oscillatory wave motor as a drive source, and proposed the structure and mechanism for integrally increasing the lifetimes of the oscillatory wave motor and the sound generation device using the oscillatory wave motor as the drive source. To maintain the drive performance of a drive unit, the drive unit is provided with a core sheathing structure, with the result that the drive unit is prevented from breaking and being damaged, and even if the entire drive unit is worn down, an intrinsic drive unit member serving as a core portion keeps the same drive area, so an initial drive feature is maintained. The descending order of a wear resistance of the members is the drive unit core material, a moving unit, and a drive unit sheathing material. In the oscillatory wave motor including a second drive mechanism, when performing an original operation of the oscillatory wave motor, a driven area on the moving unit is relatively drifted at the same time.

### TECHNICAL FIELD

The present invention relates to an increase of lifetime of an oscillatory wave motor and lifetime of a sound generation device or a sound oscillation generation device using the oscillatory wave motor as a drive source.

### BACKGROUND ART

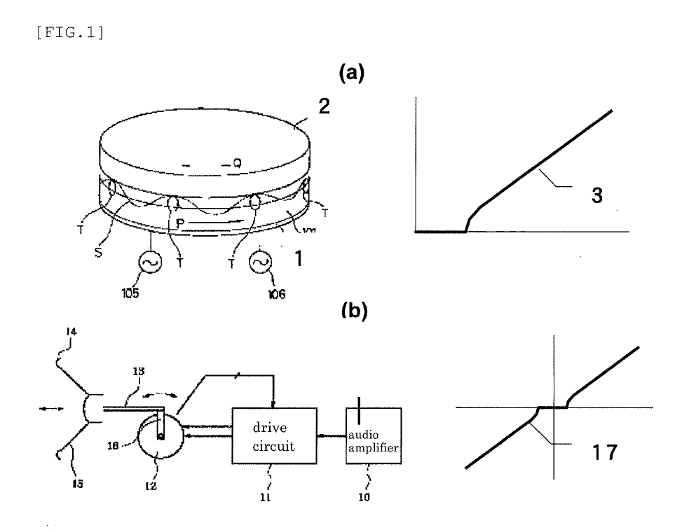

An oscillatory wave motor is one type of actuator using an oscillation wave as a drive source, and its typical example is a circular traveling wave type ultrasonic motor invented by Toshiiku Sashida. The principle diagram and speed characteristics thereof are illustrated in FIG. 1(a). The oscillatory wave motor has features such as non-magnetic, low speed and high torque, high holding torque, precise controllability, fast response, and quietness, most of which are obtained from contact drive. These features cannot be obtained from an electromagnetic motor with non-contact drive, and therefore the oscillatory wave motor has been occupying a unique place as a drive source for various machines. This is a result of having created applications utilizing one or more of the features.

In addition, the oscillatory wave motor includes a plurality of types, each of which has a feature corresponding to the principle or the application. The oscillatory wave motors in practical use can be classified into a circular traveling wave type and other types, and rotary drive is known for the former while both linear drive and rotary drive are known for the latter. In addition, as described later, the former makes contact drive in the substantially entire area of a contact ring portion, while the latter usually makes contact drive in a point or thin line contact drive area.

On the other hand, there are drawbacks due to the contact drive. The largest one is lifetime, which is 1,000 to 20,000 hours for a product on the market and is apparently shorter than that of 100,000 hours or more for an electromagnetic motor of the non-contact drive. A main cause is abrasion generated in the contact drive. It is because a friction phenomenon occurs in principle in the contact, and as a result, conversion efficiency from input power to mechanical output is low, which generates heat and abrasion. The applications used currently are usually cases where the unique performance can be utilized even with the short lifetime.

The lifetime of the oscillatory wave motor depends also on the use. The general nominal value is in the case mainly for driving an XY stage or the like, and an example in which the lifetime is shorter is a drive source for a speaker. In a speaker on the market, a voice coil motor drives a cone to oscillate, and a resonance phenomenon that is inevitable in principle occurs in a low range so that sound cannot be faithfully reproduced. In contrast, this resonance phenomenon does not occur if the drive is performed by the oscillatory wave motor. The principle diagram and speed characteristics of an example are illustrated in FIG. 1(b), and Patent Document 1 describes the technical details thereof.

In the use for a speaker, operation of the oscillatory wave motor has two major features, which include (1) constant movement and (2) home position-centered oscillation. The constant movement as the feature (1) is for reproducing a signal of sound that varies continuously. The home position-centered oscillation as the feature (2) is because a sounding body such as the cone oscillates about the origin in response to a sound signal. Further, it is apparent that influence of the two major features to the lifetime is different depending on the above-mentioned motor types as follows.

First, the features and the lifetime of the preceding circular traveling wave type oscillatory wave motor are described. As described above, in the traveling wave type, a contact drive portion between the drive unit and the moving unit always run around the entire circumference of the contact ring portion in principle. As apparent from FIG. 1(a), a traveling wave generated on the drive unit called a stator has a plurality of wave crests so as to drive the moving unit called a rotor in contact. Further, the wave crests of the traveling wave run at high speed around the entire circumference exactly as driving points. Because the point contact drive is performed basically, abrasion is supposed to be concentrated on the contact points. However, the traveling wave type has an ingenious mechanism in which the contact points, namely driving points and driven points run around substantially the entire circumference, and hence abrasion between the drive unit and the moving unit is scattered over the entire circumference without being concentrated on one point.

As to this feature, also in the use of reciprocating oscillation like the speaker illustrated in FIG. 1(b), only the moving direction of the traveling wave is frequently changed, and a substantial mechanism for the entire circumference contact drive is exactly the same. Therefore, abrasion portions on the drive unit and on the moving unit are not concentrated on specific portions but are scattered over the entire circumference. Because abrasion is not concentrated on one part, the lifetime is increased. However, the lifetime in the case of the use for a speaker is still shorter than the nominal value. In addition, as illustrated in FIG. 1(b), the speed characteristics have nonlinearity in a zero cross region, which causes a distortion.

Further, as in Patent Document 2 described later, there is a structure in which the stator and the rotor are disposed eccentrically to each other so as to change a relative position between the stator and the rotor by a moving force generated due to the driving, for aiming at a longer lifetime. However, in the use of performing only short stroke reciprocating oscillation like a speaker, the case of Patent Document 2 generates a movement only in a limited range and does not contribute to achievement of a longer lifetime.

In addition, the traveling wave rotary type that is commercially available usually uses an organic material for a contact portion or a structural part, which causes abrasion or degeneration more easily than an inorganic material. In other words, the abrasion portions are not concentrated on a specific portion but are scattered over the entire circumference so as to prevent the lifetime from being decreased, but the material restriction or the like causes fast abrasion or degeneration of characteristics. It can be said that among the above-mentioned features of speaker operation, the constant movement as the feature (1), namely being constantly moving during operation causes a decrease of the lifetime.

Improvement measures against the above-mentioned limit of the traveling wave type are other various composite vibrator type oscillatory wave motors, and a typical example thereof is a longitudinal-bending independent excitation type oscillatory wave motor. In the following, as another typical example, the longitudinal-bending independent excitation type is mainly described. In the traveling wave type, a sine wave and a cosine wave are applied to the same piezoelectric element in a superimposed manner so that a traveling wave is generated. In contrast, in the longitudinal-bending independent excitation type, longitudinal oscillation and bending oscillation are performed by separate piezoelectric element portions and are combined so as to act as a motor.

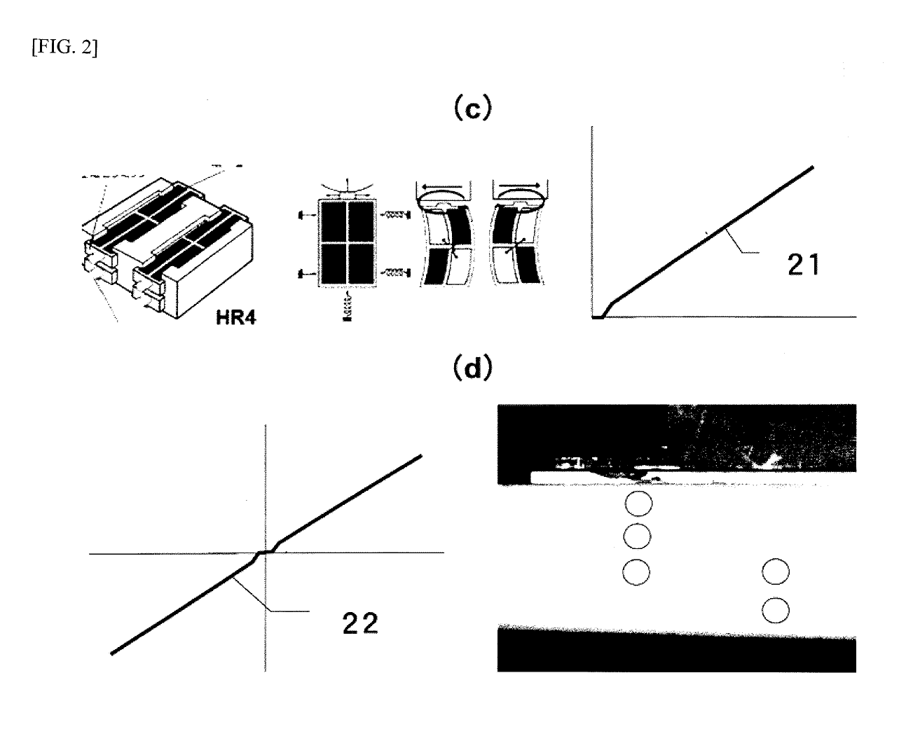

Nanomotion motor on the market is regarded as an example, and Non-Patent Document 1 describes the structure and the operation principle thereof, as well as the principle diagram and speed characteristics thereof as illustrated in FIG. 2(c). A small area drive unit drives a large area moving unit, and a driving point (namely, an abrasion point) is limited to a contact portion. In addition, the longitudinal-bending independent excitation type has a higher local pressure than that of the traveling wave type, and therefore a larger friction force is applied to the driving point. On the other hand, because the longitudinal oscillation and the bending oscillation can be controlled independently as illustrated in FIG. 2(c), the speed characteristics are better than those of the traveling wave type though still not perfect.

A general use is mainly precise positioning of the XY stage. In this case, the drive unit is fixed while the moving unit moves, and hence the driven points are expanded. Therefore, abrasion of the drive units affects the lifetime in many cases. Specifically, it is considered that metal, ceramic, or the like having high wear resistance is used for both the drive unit and the moving unit so as to secure the above-mentioned nominal value. However, even the lifetime of 20,000 hours is still shorter than that of the electromagnetic motor as described above.

In the use for a speaker, a longitudinal-bending vibrator type motor also has the same features as the oscillatory wave motor in low speed and high torque, precise controllability, fast response, and the like. However, as illustrated in FIG. 2(d), speed characteristics of the speaker driven by the Nanomotion motor still have a zero cross distortion. In addition, the speaker drive mechanism of the longitudinal-bending independent excitation type is different from that of the traveling wave type as described above, and the small area drive unit drives the large area moving unit. As a result, the home position-centered oscillation as the feature (2) in the speaker operation causes localization of the actual driven area on the moving unit, and therefore localization of abrasion. Thus, a scratch is formed as illustrated in FIG. 2(d). As a result, the lifetime is decreased. Details are described later.

The above discussions are summarized as follows. Observing at a level of the oscillatory wave motor, the traveling wave type has a short lifetime, while the longitudinal-bending independent excitation type has a relatively long lifetime. However, in the use for a speaker, because of the constant movement as the feature (1) and the home position-centered oscillation as the feature (2), the lifetime is decreased in each case because of each reason. The traveling wave motor is substantially the entire circumference contact drive type, but the drive unit or the moving unit contains an organic material in many cases. Therefore, the traveling wave motor is a degeneration type due to constant movement as the feature (1). In contrast, the longitudinal-bending independent excitation type is a point contact drive type, and therefore an abrasion phenomenon concentrated on one part due to home position-centered oscillation as the feature (2) occurs on the moving unit as described above. Thus, the lifetime is decreased. Therefore, the conventional oscillatory wave motors have a short lifetime in the use for a speaker, and hence it is difficult to be commercialized.

### CITATION LIST

### Patent Document

[Patent Document 1] JP 2007-67999 A

[Patent Document 2] JP 7-44849 B

[Patent Document 3] JP 2010-124603 A

[Patent Document 4] JP 2011-155761 A

### Non-Patent Document

[Non-Patent Document 1] “HR8 Ultrasonic Motor User Manual”, Nanomotion Ltd.

[Non-Patent Document 2] Juro Ohga, “Challenge to a speaker modulation type actuator using an ultrasonic motor”, Noise Control Vol. 34, No. 3, June, 2010, pp. 211-217

[Non-Patent Document 3] Takaaki Ishii, “Study on improvement of frictional characteristics of an ultrasonic motor”, Thesis for degree, Tokyo Institute of Technology Graduate School, 2000

[Non-Patent Document 4] Masanori Yamazaki et al., “Improvement of transmission efficiency in a belt CVT by enhancing μ between element and pulley”, Automobile Technology Essays, pp. 287-292, 39 (No. 2), March, 2008

[Non-Patent Document 5] “Small type ultrasonic actuator using an independent excitation type vibrator”, NIKKO COMPANY, Technical data p. 2, July, 2010

### SUMMARY OF INVENTION

### Problem to be Solved by the Invention

As described above, it is apparent that the oscillatory wave motors have the common drawback compared with an ordinary electromagnetic motor. Although the lifetime of the product on the market is up to 20,000 hours, the lifetime of the electromagnetic motor is 100,000 hours or longer. As a drive source for an industrial machine or a durable consumer good, the lifetime is still short. Among the technical tasks of the oscillatory wave motor, an increase of the lifetime is one of the most important technical tasks for developing other applications. The effort to increase the lifetime is also a history of the oscillatory wave motor in recent years. In particular, the inventors have been studying and developing drive sources of a sound generation device since 1994, and the largest problem for commercial production is that the lifetime is short, and it is inevitable to increase the lifetime.

The problem to be solved by the present invention is to realize a long lifetime of a longitudinal-bending independent excitation type oscillatory wave motor and a long lifetime of a sound generation device using the longitudinal-bending independent excitation type oscillatory wave motor as a drive source. The lifetime is determined by a weakest part. In the case of the oscillatory wave motor, the drive unit drives the moving unit by contact drive. Therefore, it is essential to appropriately design the both units and a relationship between the both units. In particular, the above-mentioned sound generation device has the operating features including (1) constant movement and (2) home position-centered oscillation.

First, the constant movement as the feature (1) appears regardless of a structure of the oscillatory wave motor. In contrast, in the home position-centered oscillation as the feature (2), a substantial contact portion is different depending on a structure of the oscillatory wave motor as described above. The present invention focuses attention on this point. It is an object to obtain, even in the longitudinal-bending independent excitation type, a structure in which a contacted portion of the moving unit is not fixed to the home position. Similarly, it is also considered a structure in which a substantial contact area of the drive unit does not change due to abrasion so that the characteristics become constant. It is needless to say that the above-mentioned structures cooperate to achieve a longer lifetime. In the following, prior inventions are reviewed, and problems in an experimental device to be used for a speaker are described.

First, technologies for increasing the lifetime in the prior inventions are reviewed. When this application is filed, there are 42 applications for patent and utility models related to a traveling wave motor and an ultrasonic motor including a keyword of “long lifetime”. First, the majority of the patent and utility model applications specifically indicating means or the like for increasing the lifetime are about selection of the contact member such as the drive unit or the moving unit. On the other hand, the minority of the patent and utility model applications have varieties. For instance, there is one using heat radiation or absorption means, or one by improving an applied voltage or electrodes. Further, there is one that mechanically generates odd order harmonics and decreases the friction phenomenon in principle so as to decrease the abrasion. As described above, although means are different, it is a main object of the patent and utility model applications to decrease the abrasion phenomenon due to contact friction drive between the drive unit and the moving unit.

Next, there is described a technical problem that is found in an experiment of a longitudinal-bending independent excitation type oscillatory wave motor speaker. In the case of HR8 manufactured by Nanomotion Ltd. that is the longitudinal-bending independent excitation type described in Non-Patent Document 1, drive units are arranged in a matrix of 4×2. The eight drive units drive a slider as the moving unit so as to drive a cone connected directly to the moving unit. A speaker function is to reproduce an acoustic oscillation, and the cone connected directly to the moving unit performs reciprocating oscillation centered around the home position.

However, an abnormal noise was generated during the experiment. The slider and the cone were separated so as to observe a surface of the moving unit. Then, there were found five scratches having a width of approximately 1 mm and a length of slightly shorter than 2 mm as shown in FIG. 2(d). Although the nominal lifetime is 20,000 hours, the scratches were generated after approximately 100 hours of actual operation.

On the other hand, there was no scratch on the drive unit though it was worn. Further, only the slider that was accidentally separated was oscillated by the sound signal. Then, the slider starts to move with oscillation on a rail. When a drift direction of the slider was lifted up, the movement was stopped at an angle of approximately 10 degrees and started to U-turn at an angle of approximately 15 degrees.

The drive unit of HR8 has a diameter of 3 mm in a hemispheric shape, while the moving unit has a flat surface. Because the material of the both units is alumina having a high hardness, the contact area is originally a point. However, in reality, there are found the abrasion marks having the above-mentioned size. This means that the contact drive area is substantially increased and proves that an initial drive condition is not maintained. In addition, the fact that the scratches were found in five among eight places means that a scratch occurrence probability is 63%. It was considered that only the driven area on the moving unit underwent the contact drive by the drive unit in a concentrated manner, and as a result, the abnormal abrasion occurred.

These facts indicate the following problems. First, the contact drive between alumina as a super-hard material next to diamond can cause unexpectedly rapid expansion of scratches if the scratches once start to occur.

In addition, the Nanomotion motor operates in an open environment and may involve super-hard microparticles floating in the air so that damage occurs earlier than expected. This is apparent also from the fact that the CVT is assembled in a clean room.

Further, abrasion of the drive unit changes the contact area, which naturally causes a variation of the drive force. These problems are likely to occur due to the above-mentioned home position-centered oscillation as the feature (2) in the use for a speaker. As a result, it is estimated that only the driven area of the moving unit underwent a drive load in a concentrated manner, the scratches occurred, and the lifetime was decreased. Therefore, the conventional structure cannot secure the original lifetime of the longitudinal-bending independent excitation type in the use for a speaker.

### Solution to Problem

The present invention proposes a structure and a mechanism that can integrally increase a lifetime of an oscillatory wave motor. In the present invention, there coexist three members which are a moving unit, a drive unit core material, and a drive unit sheath. Materials and surface treatments of these members have varieties, and the descending order of a wear resistance of the three members is the drive unit core material, the moving unit, and the drive unit sheath. Note that, a definition of the wear resistance is related to an abrasion amount in the case where contact friction occurs among the members. Specifically, Taber abrasion tester is used for performing the comparison.

The design policy is as follows. First, in order that the drive unit core material having a small contact area determines the lifetime of the entire motor, the wear resistance is maximized. On the other hand, compared with the drive unit core material having a small area, the moving unit has a large area. It is most preferred that abrasion of the entire area that can be contact-driven on the moving unit and abrasion of the drive unit core material occur simultaneously. Therefore, a second drive mechanism is introduced so that the entire driven area can receive a drive load from the drive unit.

On the other hand, the drive unit sheath mainly has a reinforcing function of preventing the core material from breaking and being damaged. When contacting with the moving unit, however, the drive unit sheath is scraped to be short together with the drive unit core material so as to realize a minimum wear resistance so that the moving unit is not damaged.

Further, the second drive mechanism causes the driven area on the moving unit to be relatively drifted simultaneously with the original operation of the oscillatory wave motor, and hence the drive load is distributed to a wide range.

Here, in order to further clarify features of the present invention, difference between the present invention and each of the prior examples described in Patent Documents 2, 3, and 4 is reviewed.

First, Patent Document 2 is reviewed, and after that, difference between Patent Document 2 and the present invention is described. In the circular traveling wave type of Patent Document 2, the center axis of the rotor (namely the member to be driven) is eccentric from the center axis of the drive unit (namely the stator). When the ultrasonic motor rotates, a drive force generated secondarily due to the eccentricity automatically changes and expands the region to be driven. In addition, the moving direction thereof naturally corresponds to the rotation direction of the rotor.

Therefore, when the ultrasonic motor performs sound oscillation, rotation of the ultrasonic motor remains in reciprocating oscillation within a limited range, and movement of the region to be driven can also be used only within a limited range, which does not contribute to an increase of the lifetime of the ultrasonic motor.

On the other hand, the present invention does not employ a rotation traveling wave type like Patent Document 2 but employs the longitudinal-bending independent excitation type. A driving form thereof also corresponds to both the rotation type and the linear movement type. In addition, as to the structure and mechanism thereof, the second drive mechanism is intentionally introduced. The driven points are securely drifted regardless of the movement direction of the moving unit, which contributes to an increase of the lifetime. As described above, it is apparent that the present invention is different from Patent Document 2.

Next, Patent Document 3 is reviewed, and after that, difference between Patent Document 3 and the present invention is clarified.

In Patent Document 3, claim 1 recites “the drive control unit controls the moving body to move in a predetermined range, and can move the moving body so as to change a contact region between the oscillation body and the moving body when controlling the moving body to move in the predetermined range”. In addition, Patent Document 3 performs an original operation and the movement of a drive area in different time slots.

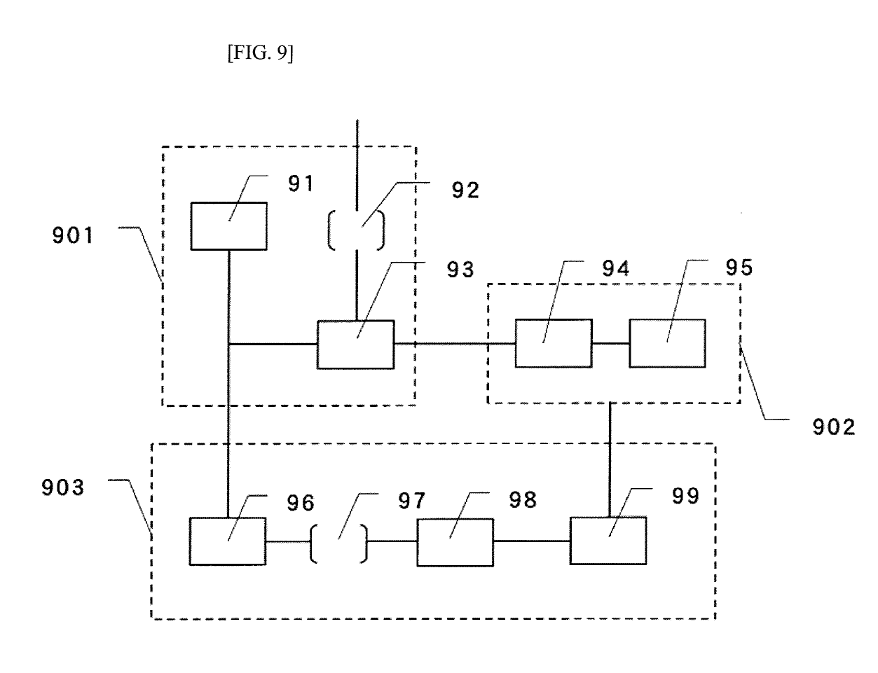

On the other hand, as illustrated in the block diagram of FIG. 9, the structure of the present invention includes a longitudinal-bending independent excitation type oscillatory wave motor drive and modulation circuit (901), a longitudinal-bending independent excitation type oscillatory wave motor (902), and a second drive mechanism (903). There is no drive control unit for controlling the entire structure, and hence it is apparent that the structure is different. In addition, because a main object of the present invention is to provide a continuously moving output as sound reproduction, it is essential that the original operation and the movement of the drive area are performed simultaneously. Also in this point, the present invention is different from Patent Document 3 which is aimed at sequential movement.

Lastly, Patent Document 4 is reviewed, and difference between Patent Document 4 and the present invention is clarified.

In Patent Document 4, claim 1 recites “a contact member at a distal end of the vibrator is constituted of a pin-shaped member, in which a contour and an area of a cross section are constant along an axial direction when being worn by frictional contact with the member to be driven”. In addition, specifically, the shape of a drive unit has a double step structure in which a base and a pin are combined.

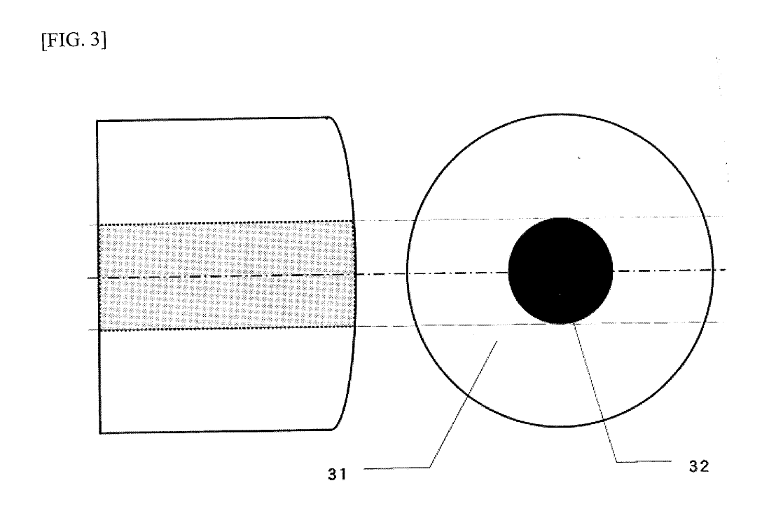

On the other hand, in the present invention, the entire drive unit has a core sheathing structure, which is apparently different from the structure of the prior example in which the only the thin drive unit protrudes from a support base. Specifically, as illustrated in FIG. 3, because the drive unit has the core sheathing structure, breakage and damage due to wearing hardly occur because of strength reinforcing effect of the sheath even in the use like a sound generation and vibration device in which a load is applied to the drive unit. Further, even if the entire drive unit is worn out, the original drive unit member as the core portion maintains the same drive area. Therefore, initial drive characteristics are maintained.

In particular, because the sound generation and vibration device is intended to always perform reciprocating vibration, and the local pressure is further increased under lubricating environment, the drive unit core material becomes thinner. Therefore, in the prior example, a stress is concentrated on the base of the drive unit so that the drive unit is prone to cause a fatigue break, and as a result it is difficult to achieve a long lifetime.

As apparent from comparison with Patent Documents 2 to 4 as the prior inventions in the above description, introduction of the moving unit drifting mechanism in the present invention and introduction of the drive unit having the core sheathing structure described above cooperate with each other to achieve an increase of the lifetimes of the oscillatory wave motor and the sound generation and vibration device.

### Advantageous Effects of the Invention

The oscillatory wave motor of the present invention can achieve a long lifetime even in the use in which a contact driven area has a tendency to concentrate on a home position or the vicinity thereof between the drive unit and the moving unit. Concretely, as illustrated in FIG. 3, the drive unit having a core-sheath structure in which the core material has high abrasion resistance so that even the core is worn out yet the same drive area is maintained. Further, by designing the materials of the core and the sheath of the drive unit and the moving unit to have previously mentioned anti-abrasion order, then even in a continuous vibration output state specific to the sounding device, the drive unit would maintain the initial characteristics in long period without snapping.

In addition, introduction of the second drive mechanism allows contact point drifting around the driven area on the moving unit simultaneously with the speaker operation. Owing to this mechanism, the to-be-contacted drive area is scattered over a wide area without being concentrated on a specific part. As a result, abrasion of the moving unit scatters over a wide area so as to contribute to an increase of the lifetime of the moving unit.

As described above, because the above-mentioned mechanism or structure is introduced, the longitudinal-bending independent excitation type oscillatory wave motor of the present invention can obtain a long lifetime not only in the use for a speaker but also a similar use of reciprocating vibration.

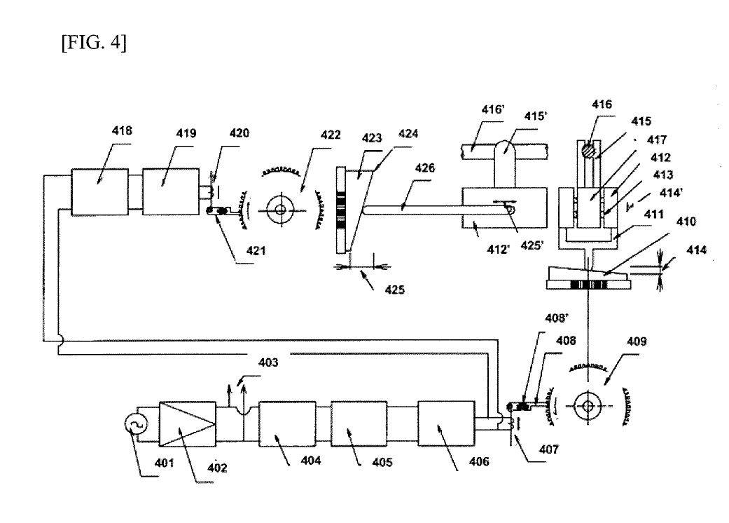

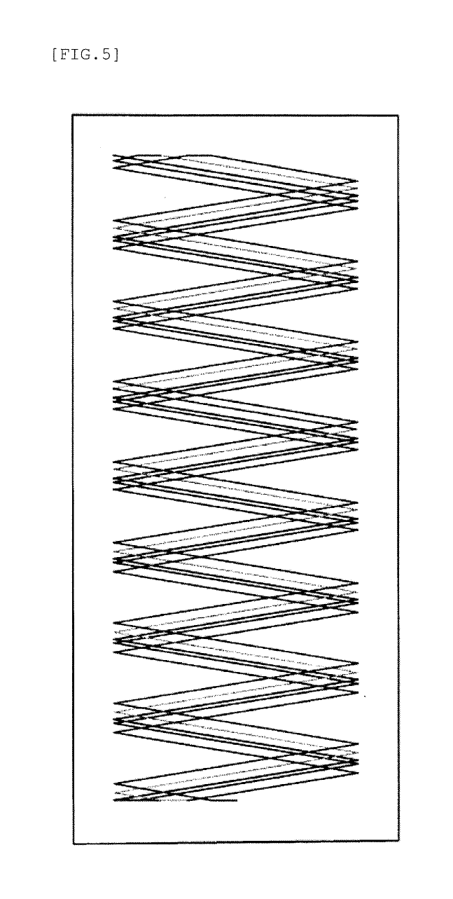

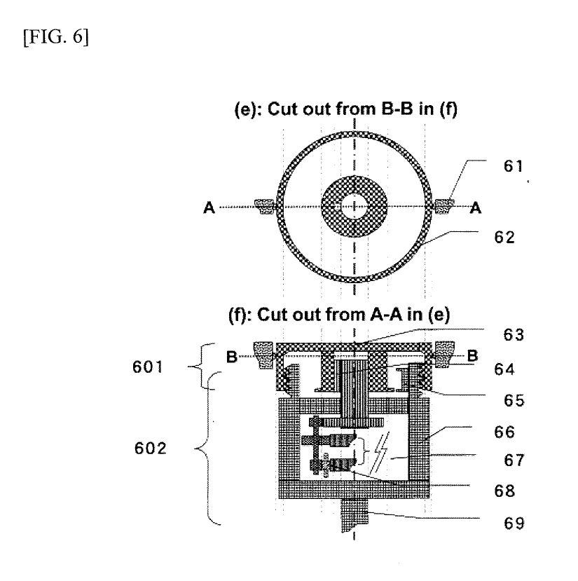

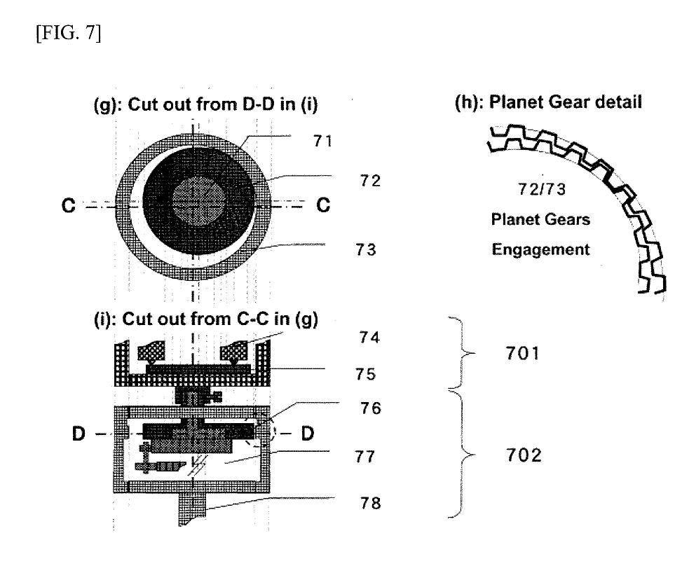

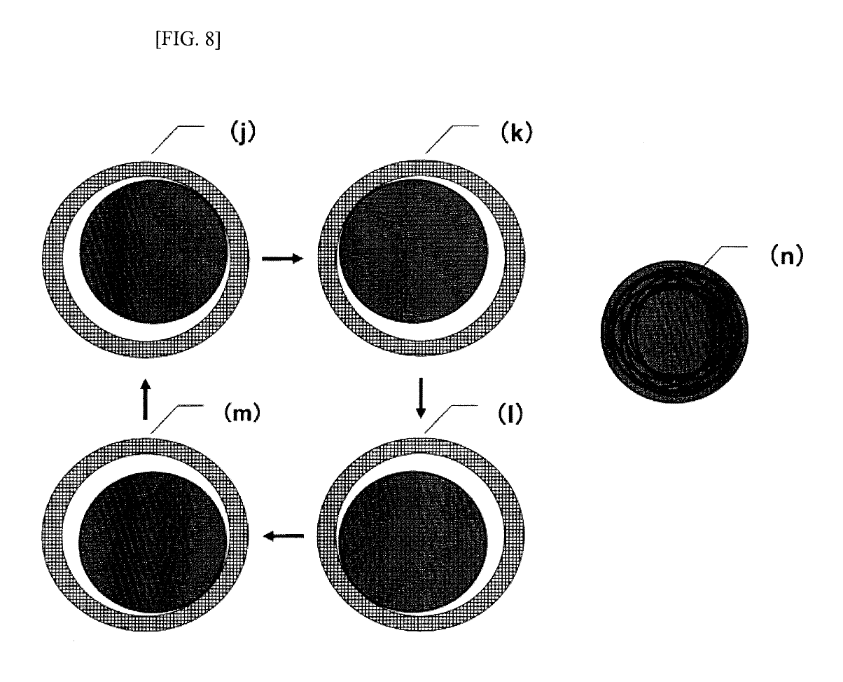

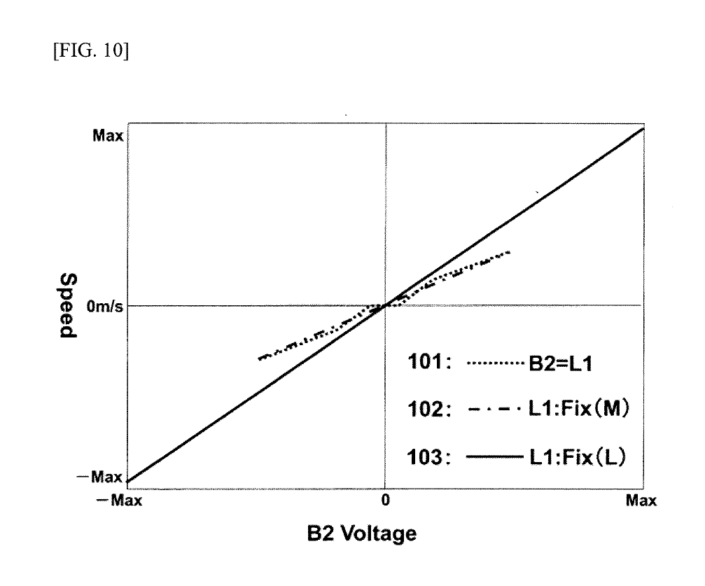

### BRIEF DESCRIPTION OF DRAWINGS

[FIG. 1] is a principle diagram of a traveling wave rotary type oscillatory wave motor and an oscillatory wave motor speaker.

[FIG. 2] is a principle diagram of a longitudinal-bending independent excitation type oscillatory wave motor and an example of an abrasion mark on a surface of a moving unit.

[FIG. 3] shows a concept diagram of a hybrid drive unit having a core sheathing structure (Example 4).

[FIG. 4] is an explanatory diagram of a drift mechanism for a contact drive portion of a linear longitudinal-bending independent excitation type oscillatory wave motor of the present invention (Example 1).

[FIG. 5] is an example of a driven locus on a moving unit of the linear longitudinal-bending independent excitation type oscillatory wave motor illustrated in FIG. 4 (Example 1).

[FIG. 6] is a principle diagram of a driven portion drift mechanism of a cylinder longitudinal-bending independent excitation type oscillatory wave motor of the present invention (Example 2).

[FIG. 7] is a principle diagram of a driven portion drift mechanism of a disc longitudinal-bending independent excitation type oscillatory wave motor of the present invention (Example 3).

[FIG. 8] is an explanatory diagram of a driven locus on a moving unit of the disc longitudinal-bending independent excitation type oscillatory wave motor illustrated in FIG. 7 (Example 3).

[FIG. 9] is a block diagram of a longitudinal-bending independent excitation type oscillatory wave motor with the second drive mechanism for driving a speaker as an example of the present invention.

[FIG. 10] shows a graph of speed characteristics of an NU-30 longitudinal-bending independent excitation type oscillatory wave motor manufactured by NIKKO COMPANY.

### MODE FOR CARRYING OUT THE INVENTION

The present invention relates to optimization for an increased lifetime of both a moving unit and a drive unit that have influence on a lifetime, especially for use in speakers and the like in which the mechanical output is home position-centered vibration oscillatory wave motor. Specifically, a hybrid type drive unit having a core-sheath structure is explained with reference to Example 4 and FIG. 3. Note that, a drive unit core material, a drive unit sheathing material, and a moving unit material are ceramic or metal, and selection, thermal treatment conditions, and the like are related to a lifetime design of the entire oscillatory wave motor. The materials and various conditions are selected in accordance with the material of the drive unit main body and a size and a shape of the moving unit.

On the other hand, in order to increase the lifetime of the moving unit, the second drive mechanism is actively introduced, so that the driven point on the moving unit is drifted. As described above, FIG. 9 illustrates an outline of the structure and mechanism as a block diagram. The second drive mechanism is different depending on a type of the longitudinal-bending independent excitation type oscillatory wave motor, namely whether the type is a linear movement type or a rotation type, and therefore Examples 1 to 3 are described with reference to FIGS. 4 to 8.

Among these three elements in the driver and the mover, the drive unit core material has a largest wear resistance in order to secure a long lifetime of the entire motor. On the other hand, the moving unit is aimed to have durability. When the moving unit is contact-driven, in order to prevent the drive unit from abrasion, the wear resistance of the moving unit is cause to be medium. The drive unit sheath is aimed to have reinforcing function to prevent breaking and damage of the core material. When the drive unit sheath contacts with the moving unit, the drive unit sheath has a smallest wear resistance and is scraped to be short together with the drive unit core material so that the moving unit is not damaged.

Specifically, the size and the material are selected in accordance with design conditions such as a local pressure to the drive unit core material and the lifetime. In addition, the wear resistance of the moving unit is set smaller than that of the drive unit, and the material and thermal treatment condition for obtaining necessary toughness are set. Further, the wear resistance of the drive unit sheathing material is set smaller than that of the moving unit. In addition, drive environment is determined. In particular, lubricating environment is desired from a viewpoint of efficiency or the like.

FIG. 9 illustrates the outline of the present invention in which the second drive mechanism drifts the driven point during operation. An ultrasonic oscillation circuit (91) is for driving the oscillatory wave motor and branches on a midpoint so as to be a second drive mechanism drive source. In addition, a sound signal (92) is an original signal for outputting sound by a speaker function. Using a modulator (93), an ultrasonic signal is modulated with the sound and drives a drive unit (94).

On the other hand, a moving unit (95) is contact-driven by the drive unit (94) and vibrates in accordance with the sound signal. In addition, a frequency divider (96) electronically divides the frequency of the ultrasonic signal into a drift signal (97), and then the signal is transformed by an electromechanical transducer (98) which moves the drive unit or the moving unit via a drift mechanism (99). Thus, a driven center point of the moving unit is drifted while mechanical vibration based on the sound signal is being generated as an original function of the drive unit.

Overlooking the above discussion, the oscillatory wave motor drive and modulation circuit (901) drives the longitudinal-bending independent excitation type oscillatory wave motor (902). The second drive mechanism (903) drifts the drive unit (94) or the moving unit (95). As a result, while the drive unit is generating the mechanical vibration based on the sound vibration, the driven point on the moving unit is relatively drifted.

Prior to further description of examples, definition of terms and reconfirmation of the contact drive portion are made. First, in the linear movement type (hereinafter referred to also as linear), the drive unit is referred to also as a stator, and the moving unit is referred to also as a slider. In the use for a speaker, in the conventional longitudinal-bending independent excitation type, the slider performs linear reciprocating vibration around a home position by the sound signal, and a short linear locus of the contact drive is generated on a surface of the slider.

On the other hand, when a longitudinal-bending independent excitation type rotationally oscillatory wave motor is used for a speaker, the drive unit is referred to also as a stator, and the moving unit is referred to also as a rotor. The former is a fixed side, and the latter performs rotationally reciprocating vibration by the sound signal in the use for a speaker. There are two rotation types, which differ at the contact drive portion between the stator and the rotor. The stator and the rotor are in contact with each other on a circumferential outer face, namely a cylinder, or on a disc disposed at an end of the cylinder. In the following, the former may be referred to as a cylinder type, and the latter may be referred to as a disc type.

In the use for a speaker, each of the cylinder type and the disc type performs short arc reciprocating vibration around a home position so that a short locus due to the contact drive is generated on the rotor.

In addition, the second drive mechanism is referred to also as a driven point drift mechanism. Then, the core sheathing structure drive unit is referred to also as a hybrid drive unit. Further, for example, FIG. 6(e) is referred to also as (e) simply.

### EXAMPLE 1

Example 1 relates to a hybrid drive unit having a core-sheath structure and is described with reference to FIG. 3. The hybrid drive unit has a shape like a pencil, around which a sheath member (91) for preventing breakage and damage of the drive unit is disposed, and in the core portion thereof, the primary drive unit (92) is disposed. Different points from a pencil are the aspect ratio, the end face shape, and the usage. The sheath is worn together with the drive unit in operation.

In the case of the prototype illustrated in FIG. 9, the aspect ratio is a length of 2.5 mm to a diameter of 3.0 mm, and a curvature of a drive end face has a radius of 30 mm. In addition, a material of a sheath (31) is aluminum. A material of a drive unit (32) is alumina, and a diameter thereof is 1.0 mm. A material of a moving unit to be driven is carbide steel having a wear resistance that is lower than that of the drive unit core material but is higher than that of the sheathing material. The order of the wear resistance is as described above. Note that, NU-30 manufactured by NIKKO COMPANY was used as the longitudinal-bending independent excitation type drive source.

### EXAMPLE 2

Example 2 is explained by FIG. 4. FIG. 4 is an example of the driven point drift mechanism of the longitudinal-bending independent excitation type linear oscillatory wave motor speaker, and an operation thereof is described below. FIG. 4 includes two parts. A lower part is an electric circuit and illustrates the process from generation of an oscillatory wave motor drive signal by the electric circuit to actual generation of an electric drive force by the second drive mechanism. An upper part illustrates generation, conversion, and transmission of a mechanical drive force based on the electric drive force, illustrates the structure and means of the driven point drift mechanism of the final linear moving unit, and illustrates an operation of a module with an increased lifetime.

Here, the electric circuit and a basis of the drive are described. The electric circuit includes an oscillator, an amplifier, a frequency reducer, a differentiating circuit, and a power amplifier. An oscillator (401) is originally for driving an oscillatory wave motor, and in this case generates an electric signal having a frequency of approximately 55 to 56 kHz, and the signal is divided into two circuits after passing through an amplifier (402).

One signal (403) enters a driver via a sound modulator and an amplifier, and drives the drive unit as an original oscillatory wave motor so as to generate mechanical vibration in accordance with the sound signal. The other signal is reduced by a frequency reducer (404) to approximately 1/560,000 so as to generate an electric signal of approximately 0.1 Hz, which is differentiated by a differentiating circuit (405) so that a pulse per 10 seconds is generated.

This pulse is applied to a one-shot multivibrator and a power amplifier (406), so as to generate a rectangular wave having a time width of 0.2 to 0.3 seconds every ten seconds, which is supplied to a plunger (407) for moving in the up and down direction. A rod (408) is linked to a shaft that is absorbed by the plunger, and a distal end thereof engages with teeth of a gear (409) so as to rotate the gear (409) by one tooth corresponding to one pulse. The gear is designed so that the rod is in the same relative position with the next tooth when the pulse is finished.

There is a spring (408′) for restoring the same positional relationship, which changes a length of the rod (408) so as to restore the original position easily. If the gear (409) has 60 teeth, for example, the gear (409) rotates one turn in 10 minutes.

Further, a movement of a motor main body support device in the up and down direction in Example 2 is described. The backside of the gear (409) is a cam (410), and a distal end of a motor main body support device (411) is held in contact with a surface of the cam. When the gear rotates, the motor main body support device (411) also performs one reciprocating movement in the up and down direction in approximately 10 minutes. In this example, a length of the reciprocating movement is set to 3 mm.

The movement of the motor main body support device (411) causes motors (412) to move in the up and down direction, because it is sandwiching a slider (407), hence the stator (413) which is fixed to the motor and oscillated by piezo elements to be vibrated is also moved in the up and down direction by 3 mm against the reciprocating manner.

On the other hand, the slider (417) is vibrated by the stator on the basis of the sound signal and performs reciprocating vibration for sound reproduction along a rail (416) by support of a slider support portion (415). The vibration is transmitted to a speaker via a link mechanism. Note that, this second movement mechanism module is linked directly to fixed coordinates, while the slider is supported by upper and lower guide rails for maintaining an original speaker drive shaft, although illustration is partially omitted in the diagram.

Next, the movement in the horizontal direction of the motor main body support device of Example 2 is described. An output of the power amplifier (406) branches and is further reduced to 1/16 by another frequency reducer and a differentiating circuit (418) to be a pulse of 0.006 Hz, which is amplified by a power amplifier (419) and is applied to a plunger (420). In this way, by the same mechanism as described above, a gear (422) is rotated by one tooth in 160 seconds.

There is a rod (421) linked to the plunger. If the gear has 60 teeth, the gear (422) rotates one turn in 160 minutes. A front side of the gear (422) is a cam (423), and a distal end of a motor main body support device (426) is held in contact with a surface of the cam. When the gear (422) rotates, the motor main body support device (426) is moved.

Thus, a motor (412′) oscillated by the piezoelectric element and the like is also moved relatively in the oscillation direction by 8 mm in the reciprocating manner. However, the cam (423) accompanying the gear (422) is different from the cam (409) described above in that the apex is flat over a length (424) corresponding to 1/160 of the entire circumference. Therefore, horizontal movement is stopped in this part. As a result, movement in the vertical direction is shifted so that contact points are distributed uniformly in the area of 3 mm and 8 mm.

FIG. 5 illustrates an example of the drift locus of a driven point of Example 2. In this way, because the locus of the contact points between the stator and the slider on the moving unit is scattered over a wide area, the lifetime of the oscillatory wave motor speaker, which is the longitudinal-bending independent excitation type and linear movement type, can be largely increased as an effective technology.

### EXAMPLE 3

An outline of Example 3 is described with reference to FIG. 6. FIG. 6 includes FIG. (e) and FIG. (f), in which the entire diagram represents a longitudinal-bending independent excitation type cylinder oscillatory wave motor in an ordinary concept. Hence the substance thereof includes a motor and cylinder movable unit (601) in a narrow meaning and a drift module (602). FIG. (e) and FIG. (f) are cross-sectional views corresponding with each other.

FIG. (e) illustrates a drive unit of an oscillatory wave motor portion, and is a B-B cross-sectional view of FIG. (f) described below. On the other hand, FIG. (f) illustrates an oscillation wave motor portion and a drift module, and is an A-A cross-sectional view of FIG. (e). There is illustrated a mechanism in which the cylinder movable unit (601) receives a moving force from the drift module (602) and is rotation-shifted at very slow speed in a spiral manner.

To start with, a first half of operation in Example 3 is described. As described above, FIG. (e) illustrates a cross section of a cylinder contact drive portion, which is the B-B cross section of FIG. (f).

Motor main bodies (61) positioned opposite each other with a cylinder face (62) in the A-A portion. In the case of the oscillatory wave motor speaker, two drive units of the motor (61) perform reciprocating vibration along the circumference on the basis of the sound signal, and the cylinder face (62) as a representative of the drift module (601) receives the drive so as to drive the sounding body via a drift module shaft (68) and a link mechanism (not shown). Thus, sound is produced.

In this case, the cylinder face (62) can be regarded to be substantially integrated with the rotor. In addition, the cylinder face is the moving unit itself, and its material, thermal treatment condition and the like are selected on the basis of the conditions described above. In accordance with the operating time, a rotor (63) rotates in a spiral manner at very slow speed with respect to a drift module (65) so as to change the contact portion. The very slow speed means a movement of approximately 1 mm per minute, which is a level of travel of the minute hand in a quartz watch.

Next, a very slow speed spiral rotation drift mechanism that is a main function of the drift module (602) as a second half of Example 3 is described. FIG. (f) is related to the very slow speed spiral rotation of the rotor (63) in a narrow meaning and a mechanism for scattering and expanding the contact area.

The rotor (63) in a narrow meaning is linked to a keyed drive shaft (64) via a hole with a keyway which hole is provided in the center part of the shaft. Fastening by press spring and a mechanical damping member are used for aid in the keyway portion as necessary so that no play occurs. This keyed drive shaft (64) is driven in a drift module casing (66) by a very slow speed drift drive source (67) which is like a quartz watch.

Simultaneously, a screw disposed in an inner circumference portion of the rotor (63) in a narrow meaning is engaged with a screw disposed in an outer circumference portion of the drift module casing (66) so that the entire rotor portion (601) rotates at very slow speed. In addition, the entire rotor portion not only rotates along the circumference at very slow speed but also moves gradually in the direction parallel to the shaft. Therefore, the contact portion on the rotor (63) in a narrow meaning moves spirally on the cylinder face (62).

When a position sensor (65) detects a turn-around point, the drive source (67) (not shown) is moved upward or downward so that the drift direction is reversed via a reversing gear (68). Because of a play in a gear portion, a limited time elapses until reversing operation. As a result, a reversing locus is different from an exact inversion. Therefore, it inevitably results in the scattering and expanding the contact drive area. The reciprocating rotation oscillation based on the original sound signal is transmitted from the drift module shaft (69) to the sounding body.

### EXAMPLE 4

Here, Example 4 is described with reference to FIGS. 7 and 8. FIG. 7 comprises an oscillatory wave motor (701) in a narrow meaning and a drift module (702). Both of the oscillatory wave motor and the drift module can be removed and attached by a set screw. FIGS. 7 and 8 are conceptual diagrams of a contact drive portion drift mechanism of the longitudinal-bending independent excitation type disc-rotation oscillatory wave motor and illustrate a sub system of the oscillatory wave motor speaker. Further, FIG. 8 is an explanatory diagram of a contact locus example and the like on the disc rotation oscillatory wave motor shown in FIG. 7.

To start with, a first half of the operation of the longitudinal-bending independent excitation type disc oscillatory wave motor in Example 4 is described with reference to FIG. 7, which includes three portions. FIG. (g) is an explanatory diagram of a mechanism of a main function of the drift module (702) for scattering the locus to a wide area, which is a D-D cross-sectional view of FIG. (i), and includes an eccentric cam (71), a planetary rotation gear (72), and a drift module main body gear portion (73).

FIG. (h) is an enlarged view of an engaged portion between the drift module inner face fixed gear (73) and the planetary rotation gear (72). As described above, FIG. (h) is a D-D cross-sectional view of FIG. (i), and the eccentric cam (71) rotates at very slow speed when receiving the drive force described below. On the other hand, FIG. (i) is a C-C cross-sectional view of FIG. (g), and illustrates the main body portion (701) of the disc rotation oscillatory wave motor, a part of which is omitted in FIG (i) and the drift module (702).

Next, a second half is described. The very slow speed shift rotation of the planetary rotation gear (72) is, as illustrated in FIG. (i), directly connected to a disc rotor (75) in the oscillatory wave motor via a connector. As a result, the locus of the driven portion on the rotor (75) by a drive unit (74) is scattered to a wide area.

In order to enable this operation, the drive units (74) are disposed at a symmetric position with respect to the rotation center of the drift module (702), so as to form the oscillatory wave motor (701) together with the rotor (75) described above. On the other hand, as to the drift module (702), similarly to the cylinder type described above, a drive source (77) (not shown) rotates the eccentric cam (71) at very slow speed in proportion to the operating time.

A drift module shaft (78) drives the sounding body similarly to Example 3. In addition, similarly to the cylinder type, it is useful to use a press spring and to carry out a damping treatment so that the very slow speed drift mechanism does not cause an undesired resonance in acoustic vibration. The drift speed of the driven portion in this case is also approximately 1 mm per minute in actual operation time.

As a result, because the center of the driven portion swings on the disc, the driven portion continues to draw a circular figure whose center moves gradually, while drifting at very slow speed. A typical locus example is illustrated in FIG. 8 and is described below in detail.

As described above, FIG. 8 illustrates a movement of the disc by the second drive mechanism and a locus example generated in FIG. 7, as the result from the working of the longitudinal-bending independent excitation type disc rotation oscillatory wave motor speaker. FIG. (j), FIG. (k), FIG. (l) and FIG. (m) illustrate typical relative positions when a driven surface on the disc is planetary-rotationally shifted by the mechanism illustrated in FIG. 7.

FIG. (n) illustrates an example of a driven locus group after the planetary movement of the rotor has occurred many times along with use of the motor. An actual locus is a type of cycloid and is different depending on a planetary gear ratio and an arrangement of the drive unit. It is preferred to determine specifications such as the gear ratio and the arrangement of the drive unit so as to expand the locus while decreasing an overlapping portion between driven contact orbits and to utilize the most of the effective contact surface on the disc.

In this way, a form of the figure drawn by the contact drive portion, a place where the figure is generated, and the way the contact points are scattered are different depending on the linear type, the cylinder type, or the disc type. However, it is common to scatter the driven portion to a wide area as the main object of the present invention. In addition, it is also useful to scatter a contact portion to a wide area in a similar way not only in a point contact system but also in a line contact system.

Further, as a common technology, it is possible to use a quartz clock drive source or, as described above in Example 2, an oscillation mechanism of an oscillatory wave motor as a drive source of means for drifting the contact portion to other than the original locus. If a quartz clock is used, because it can be driven by a battery, wiring is not necessary even if the drift module is disposed on the moving unit side.

In this example, a size of the entire drive unit is substantially the same as a size of each drive chip of HR8, but the effective contact drive area is not expanded to the entire cross-sectional area of a diameter of 3 mm unlike the HR8 even if the abrasion proceeds, and does not exceed a diameter of 1 mm at most.

It is preferred that the sheath member has such property that a wear resistance is lower than that of the moving unit as described above and a toughness fulfills a role of reinforcing, and that a specific gravity is small so that variation of the mass is little after the abrasion. In addition, if the specific gravity is large, variation of the mass is large so that a drive condition such as a resonance frequency is apt to change. From this view point, aluminum is useful.

Further, an advantage of using the vibrator motor drive source not in a normal dry environment but in a lubricating environment is described. The conventional traveling wave rotary type oscillatory wave motor is used in a dry environment from the beginning. It is because the oscillatory wave motor, in principle, employs a method of generating a drive force by friction drive, which is not compatible with lubricant.

However, it was found in the later study that a certain lubricating action is useful even in a dry environment, and in some models, a solid lubricating agent is substantially used in the frictional surface. Some of the inventors are carrying out studies to dramatically increase the efficiency and the lifetime by more actively introducing a lubricating environment. There is already a result of efficiency of 72% that is almost twice of that in the dry environment (Non-Patent Document 3). It is naturally useful to utilize the advantage also in use for the longitudinal-bending independent excitation type oscillatory wave motor speaker.

Ina lubricating environment, a local pressure increases, and hence the control is more important than in a dry environment. It is known that when lubricant is used, the drive unit area is decreased in order to increase the local pressure and a tangential force coefficient of a sliding surface largely changes depending on the pressure, and the behavior thereof is explained by a Stribeck curve.

As a matter of course, the pressure in this case indicates a local pressure in a microscopic meaning. Even if an external pressure is the same, when the contact area changes, the tangential force coefficient changes as a matter of course. For instance, if a microscopic contact area increases by one digit by abrasion of the drive unit, the local pressure is inversely decreased by one digit. Then, variation of the friction drive force is further increased, according to the Stribeck curve.

Therefore, in order to utilize the advantage of the lubricating environment, it is inevitable to maintain constancy of the substantial contact area described above. Further, it is also useful for ensuring the operation environment to absorb abrasion dust generated inevitably in the operation as sludge into the lubricant without scattering the dust, and to add a chelate compound or the like for detoxifying the sludge.

In addition, there is described a technology to form a microscopic matrix on the surface of the drive unit in the drive source in the lubricating environment. This knowledge is obtained from a CVT (Continuously Variable Transmission) (Non-Patent Document 4) that is apparently unrelated. A technology for controlling a shape of a driven surface that is useful for improving efficiency in a belt CVT continuous variable transmission system is introduced to a study of the oscillatory wave motor.

In particular, improvement of friction coefficient by combining a microscopic structure of a contact surface on the drive side and a type of lubricant is expected to be useful also for improving efficiency of the oscillatory wave motor as a result, and control of the parameter Dsum is particularly noticed. Further, as being utilized in CVT lubricating oil, a chemical surface modification technology using an additive metal salt can be used. These technologies are useful not only in the use for the oscillatory wave motor speaker but also in an ordinary use, namely in a use for positioning, and have wide applications.

Further, in order to keep the lubricating environment, similarly to the CVT, it is necessary to be isolated from the outside world. This is necessary for preventing leakage of the lubricating oil and for preventing dust of super-hard materials from entering from outside.

Other than that, there are many industrial known methods for maintaining an effective drive area. For instance, there are a bunch of whiskers bound with metal or inorganic material, and abrasive grains seen in various tool bits, which are solidified with sintered metal. In the stage of designing each of methods, the material, size, and thermal treatment condition of the drive unit and the moving unit described above are selected in accordance with an assured lifetime, operating condition and cost, on the basis of design specification of the oscillatory wave motor.

Finally, features concerning power consumption of the longitudinal-bending independent excitation type oscillatory wave motor speaker and how to achieve smarter power are described. First, power consumption thereof is compared with that of an electrodynamic type speaker. As described above, the electrodynamic type speaker is a transducer, and a relationship between sound output and power consumption is a proportional relationship, namely, y is proportional to x. In this case, y represents reproduced sound pressure, and x represents input power.

On the other hand, it is apparent that the longitudinal-bending independent excitation type oscillatory wave motor speaker is different. The sound output and the power consumption can be expressed by a relationship that y is proportional to bx′+l, where “b” represents a bending oscillation voltage, and “l” represents a coefficient related to a longitudinal oscillation voltage. This indicates one type of modulation types. In other words, the sound output and the input voltage have a linear relationship. Here, y represents the same sound output, and x′ represents not a power but a sound signal voltage. A detail relationship between x′ and power is profound, and therefore future study is expected.

Comparison of power consumption between the both cases is as follows. In the electrodynamic type, as described above, the sound output and the power consumption are always proportional to each other. In contrast, in the longitudinal-bending independent excitation type oscillatory type motor speaker, when “b” is 1 or smaller, there is an area in which power consumption of the speaker can be reduced. For instance, in the case of the Nanomotion, “b” is approximately 0.3. Increase of power consumption for increasing sound pressure by 10 times was approximately three times. In other words, as to the longitudinal-bending independent excitation type oscillatory wave motor speaker, a certain volume or higher can be attained with a lower power compared to the conventional electrodynamic type.

Next, smartization is described. The sound signal voltage has a very large difference between an average output and a peak output. Noticing this point, smartization was studied from two viewpoints. The noticed points were (3) master volume and (4) adaptation process. The master volume of the point (3) is set by a user in the reproduction process. Internally, the master volume is directly connected to a maximum value of a reproduction sound pressure. Specifically, the master volume has substantially the same meaning as determining the maximum value “b” in sound reproduction, and “l” was set within a limited width.

FIG. 10 shows speed characteristics due to variations of B2 and L1 in the longitudinal-bending independent excitation type oscillatory wave motor NU-30 manufactured by NIKKO COMPANY. A dotted line indicates a case where B2=L1, namely the both B2 and L1 are changed, which has a dead zone in the zero cross region. On the other hand, the case of L1:Fix(M) illustrated by a dashed dotted line has no dead zone in the zero cross region.

In this case, L1:Fix(M) was 3.3 Vrms. In addition, L1:Fix (L)=11 Vrms is illustrated by black. The master volume is directly connected to the maximum value of the reproduction sound pressure. Specifically, the master volume has the same meaning to determine the maximum value of “b” in the sound reproduction, and “l” was set within a limited width by a look-up table or the like. Comparing L1:Fix(L) with L1:Fix(M), the linear term “l” sufficiently works at 30% of the maximum value.

On the other hand, the adaptation process of the point (4) is aimed at further reduction of power by utilizing a variation of the sound signal voltage while keeping sound conversion efficiency at constant as a motor drive condition in a small volume. However, in order to aim at this smartization, the control factors are inevitably increased. This is because another control factor is essential for performing dynamic control, although it is not necessary to consider the factor in the above-mentioned statistic setting of B2 and L1.

See FIG. 10 again. The coefficient of the speed characteristics is L1:Fix(L) of 0.20 m/s for black and L1:Fix(M) of 0.12 m/s for red. If the sound input voltage is the same, there is a difference of approximately 5 dB in the sound output.

This difference is compensated by automatic volume control (AVC) that is used for an AM radio so that the sound output is kept at constant. Note that, a normal AVC is used for controlling a maximum input, yet on the other hand, the opposite usage is employed here. Specifically, a small sound input voltage is boosted. This gain is expressed by “g”, and then “y becomes proportional to gbx′+l” is satisfied, in which a decrease of “b” is compensated by “g”.

Specifically, on the basis of grasping the sound signal voltage in advance, smartization is performed when x′ has a tendency to vary greatly. This operation utilizes the fact that a mechanical operation is delayed by millisecond order. An envelope of the sound signal is grasped in advance to estimate the amplitude. If the amplitude is increasing, “l” was increased prior to the sound signal. On the other hand, if the amplitude is decreasing, on the other hand, “l” was decreased to follow the signal.

By this adaptation process, even if the master volume is maximum, the substantial “l” is reduced and adapted as much as possible depending on the sound signal voltage. As a result, smartization of the input power can be achieved.

Summarizing the above discussion, the longitudinal-bending independent excitation type oscillatory wave motor speaker, as being a modulator, can contribute to power saving compared with the conventional type, and further contribute to audio smartization by the adaptation.

### INDUSTRIAL APPLICABILITY

When the longitudinal-bending independent excitation type oscillatory wave motor is used for driving a speaker, the lifetime can be increased by preventing a variation of a contact drive force due to abrasion of the drive unit and by preventing local abrasion of the moving unit. In addition, the lifetime can be longer than that of a conventional product also when the motor is used in a case where oscillation is reciprocating vibration similar to a speaker or an operation program is in a fixed form.

### REFERENCE SIGNS LIST

1. stator

2. rotor

3. motor speed characteristics

10. audio signal source

11. drive device

12. rotary type oscillatory wave motor

13. connection rod

14. edge

15. cone

16. arm

17. speaker speed characteristics

21. motor speed characteristics

22. speaker speed characteristics

31. drive unit core

32. drive unit sheath

401. oscillatory wave generation circuit

402. amplifier

403. divided signal

404. frequency reducer

405. differentiating circuit

406. one-shot multivibrator and power amplifier

407. plunger

408. rod

409. gear

410. cam

411. motor main body support device

412, 412′. motor

413. stator

414, 414′. (length of movement of 3 mm)

415, 415′. slider support portion

416, 416′. guide rail

417. slider

418. differentiating circuit

419. one-shot multivibrator and power amplifier

420. plunger

421. rod

422. gear

423. cam

424. flat apex of cam

425. (length of movement of 8 mm)

426. motor main body support device

61. motor main body

62. cylinder face

63. rotor

64. drive shaft with keyway

65. position sensor

66. shift module

67. quartz clock oscillation portion

68. reversing gear

69. shift module shaft

601. cylinder movable unit

602. shift module

71. eccentric cam

72. disc portion of rotor

73. shift module and gear portion

74. motor main body in narrow meaning

75. rotor

76. engagement portion of planetary rotation gear

77. quartz clock drive source (not shown)

78. shift module shaft

701. oscillatory wave motor in narrow meaning

702. shift module main body

(j). position example of disc at position 1 of representative planetary rotation gear

(k). position example of disc at position 2 of representative planetary rotation gear

(l). position example of disc at position 3 of representative planetary rotation gear

(m). position example of disc at position 4 of representative planetary rotation gear

(n). example of driven contact locus on disc during operation of motor

91. ultrasonic transmission circuit

92. sound signal

93. modulator

94. drive unit

95. moving unit

96. frequency divider

97. drift signal

98. electromechanical transducer

99. drift mechanism

901. drive and modulation circuit of longitudinal-bending independent excitation type oscillatory wave motor

902. longitudinal-bending independent excitation type oscillatory wave motor

903. second drive mechanism

101. B2=L1 where bending second-order oscillation voltage=longitudinal first-order oscillation voltage

102. L1:Fix(M) where longitudinal first-order oscillation voltage is fixed at maximum value

103. L1:Fix(L) where longitudinal first-order oscillation voltage is fixed at lowest value

1. An oscillatory wave motor in which a drive unit drives a moving unit by contact drive, wherein the drive unit has a core-sheath structure, the core material is the drive unit itself and the sheathing material is a reinforcement material, and the descending order of a wear resistance of the these members is the drive unit core material, the moving unit, and the drive unit sheath.

2. The oscillatory wave motor as claimed in claim 1, which comprises, in addition to a first driving mechanism in which the drive unit drives the moving unit by contact drive, a second driving mechanism in which the moving unit moves to a direction different from the direction that the moving unit is moved by the first driving mechanism, which is equivalent to an area of the contact drive.

3. The oscillatory wave motor as claimed in claim 1, wherein a main portion, including an interface on which the contact drive is performed, except an end of output axis of the driving unit force provided by the moving unit is placed in an enclosed region, and lubricant is sealed in the enclosed region.

4. The oscillatory wave motor as claimed in claim 1, wherein the core of the drive unit is a columnar or polygonal columnar shape in order to fulfill its primary function to withstand oscillatory load for a long period of time, the sheath prevents the core from breaking or being damaged due to the oscillatory load for a long period of time as a main function, the core and the sheath may have not only a single layer structure but a multi-layer structure, and the core and the sheath of the drive unit are worn out simultaneously with the friction driving between the moving unit while the oscillatory motor is used even for a long period of time.

5. A sound generation device generating a sound oscillation or a sound vibration generation device, wherein the drive source is the oscillatory wave motor as claimed in claim 1.

6. The oscillatory wave motor as claimed in claim 1, wherein the moving unit has a flat surface and the area of the contact drive vibrates and moves on the moving unit.

7. The oscillatory wave motor as claimed in claim 1, wherein the moving unit has a cylindrical surface and the area of the contact drive oscillates and moves on the moving unit.

8. The oscillatory wave motor as claimed in claim 1, wherein the moving unit has a disc surface and the area of the contact drive oscillates and moves on the moving unit.

9. The oscillatory wave motor as claimed in claim 1, wherein the locus left by the contact drive area moving on the moving unit with the second drive mechanism is an overlapping of the repeated rectangular waves, spirals in folds on the outer surface of the cylinder, or repetition of a kind of cycloid.

10. The sound generation device generating the sound vibration or the sound oscillatory generation device as claimed in claim 5 comprising the oscillatory wave motor as claimed in claim 1 as a drive source, wherein drive electricity is appropriately controlled depending on generated sound pressure or oscillation amplitude.
